(19) United States
(12) Patent Application Publication
(10) Pub. No.: US 2005/0138440 A1
(43) Pub. Date: Jun. 23, 2005

(54) Equipment rack load modulation system and method

(76) Inventors: Andrew Harvey Barr, Roseville, CA (US); Kirk Michael Bresniker, Roseville, CA (US); Ricardo Espinoza-Ibarra, Lincoln, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/742,495

(22) Filed: Dec. 18, 2003

(51) Int. Cl. G06F 1/30

(52) U.S. Cl. 713/300

(57) ABSTRACT

An equipment rack load modulation system and method are presented. An equipment rack aggregate thermal and power budget is determined. The aggregate thermal and power budget is allocated based upon rack equipment loaded in an equipment rack. The rack equipment is then operated in accordance with the allocation of the aggregate thermal and power budget.

### FIELD OF THE INVENTION

The present invention relates to rack equipment management.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data, ideas and trends in most areas of business, science, education and entertainment. Frequently, electronic systems designed to provide these advantageous results are realized through the leveraged utilization of centralized resources by distributed network nodes. While leveraged utilization of centralized resources is usually advantageous, optimally balancing rack loading and associated performance parameters of centralized resource operations is usually very difficult.

Centralized computing resource centers (e.g., server farms, Application Service Provider Centers, Internet Data Centers, Utility Data Centers, etc.) usually include a variety of equipment related to information processing mounted in racks. The racks usually provide a convenient and efficient way to arrange computing equipment in a centralized operation location. The number and different types of rack equipment that are typically loaded in a rack can have significantly different performance capabilities and load demands. Balancing the rack loading from minimal to maximum capacity raises many challenging operational issues.

The differences in rack equipment typically included in centralized computing resource racks usually increases the complexity and difficulty of efficient rack equipment loading. For example, equipment racks usually have a power and thermal “budget” that corresponds to predetermined power use and thermal dispersion limits. Loading a rack with equipment that operates within the overall rack power and thermal budget is often problematic. For example, the power consumption and thermal profile of typical rack equipment (e.g., server computers) is such that more rack equipment can be physically located or “housed” within a rack than can be cooled and/or power continuously provided for. In addition, conventional tendencies for operating rack equipment at fixed predetermined performance levels does not promote efficient use of a power consumption and heat dissipation budget. Traditional attempts at maintaining rack power and thermal budgets by limiting the amount of equipment loaded in a rack usually results in more racks occupying precious floor space. Traditional attempts also sometimes limit rack equipment loading to rack equipment with relatively low power operating characteristics which can result in significant performance limitations and/or the need for additional equipment to make up for the performance limitations.

### SUMMARY OF THE INVENTION

An equipment rack load modulation system and method are presented. An equipment rack aggregate thermal and power budget is determined. The aggregate thermal and power budget is allocated based upon rack equipment loaded in an equipment rack. The rack equipment is then operated in accordance with the allocation of the aggregate thermal and power budget.

### BRIEF DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is an illustration of an equipment rack load modulation system in accordance with one embodiment of the present invention.

FIG. 2 is an illustration of a loading budget implementation component in accordance with one embodiment of the present invention.

FIG. 3 is a flow chart of an equipment rack load modulation method in accordance with one embodiment of the present invention.

FIG. 4 is a block diagram of one embodiment of a computer system on which the present invention can be implemented.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some readily understood methods, procedures, components, and circuits have not been described in detail as not to unnecessarily obscure aspects of the current invention.

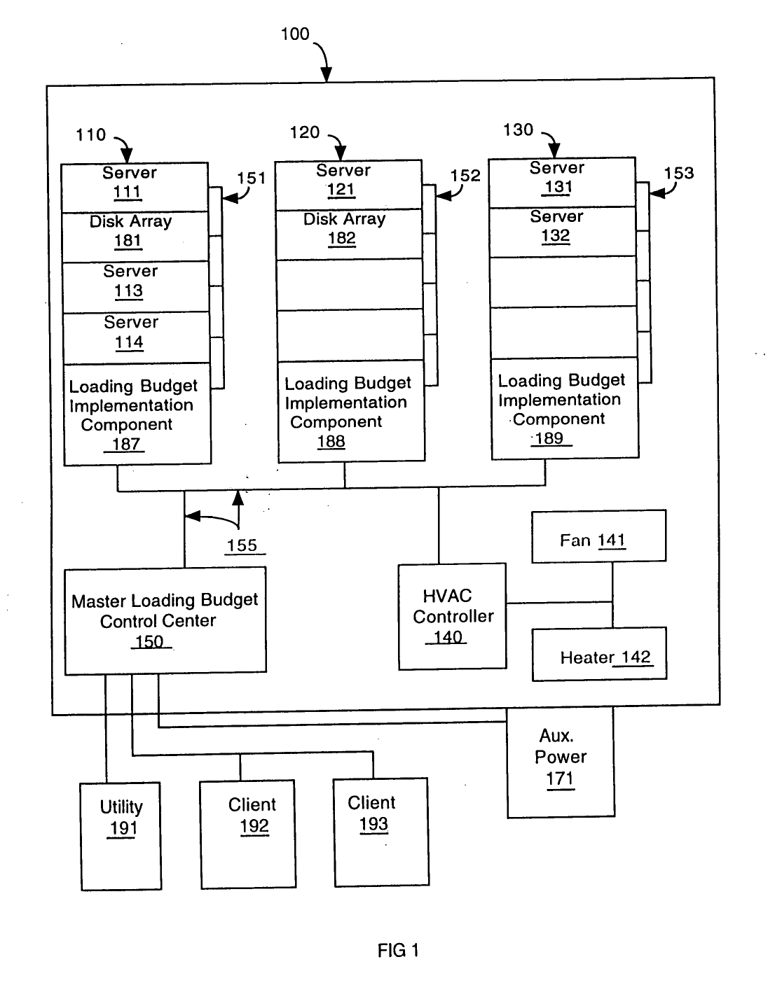

FIG. 1 is an illustration of equipment rack load modulation system 100, in accordance with one embodiment of the present invention. Equipment rack load modulation system 100 includes a plurality of racks 110, 120, and 130, master loading budget control component 150, and heating, venting and air conditioning (HVAC) controller 140. Equipment racks 110, 120 and 130 comprise servers 111 through 132, disk arrays 181 and 182, and loading budget implementation components units 187, 188 and 189. Master loading budget control component 150 is communicatively coupled to equipment racks 110, 120, and 130, and HVAC controller 140 through communication channel 155.

The components of equipment rack load modulation system 100 cooperatively operate to process information and modulate operating conditions to accommodate different equipment rack loading configurations. The plurality of servers 111 through 132 process information. Disk arrays 181, and 182 store information for processing. Loading budget implementation components 187, 188 and 189 modulate rack equipment operation based upon a loading budget allocation policy. In one exemplary implementation, the loading budget allocation policy corresponds to loading of equipment included in equipment racks 110, 120, and 130. Master loading budget control component 150 coordinates the changes “between” racks 110, 120 and 130 and equipment (e.g., HVAC controller 140) that support operations of multiple racks in accordance with a loading budget policy. Master loading budget control component 150 also communicates with utility 191, auxiliary power 171 and information processing clients 192 and 193. For example, master loading budget control component 150 can receive changes in loading budget policy information from processing clients 192 and 193.

The communication links included in the equipment rack load modulation system 100 communicate information between components of system 100. Communication link 151 communicatively couples loading budget implementation component 187 to other equipment (e.g., server 111, 112 and 113 and disk array 181) in rack 110. Communication link 152 communicatively couples loading budget implementation component 188 to other equipment in rack 120. Communication link 153 communicatively couples loading budget implementation component 189 to other equipment in rack 130. Communication link 155 communicatively couples master loading budget control component 150, loading budget implementation components 187, 188, and 189, and HVAC controller 140. There are a variety of configurations that are compatible with present invention communication links. A present invention communication link can be established by “injecting” (e.g., modulating) a signal on a power cord (e.g., AC or DC line cord), an RS-485 system an Ethernet 10/100/1000bT local area network (LAN) and/or wireless communications channels.

Loading budget implementation components 187, 188, 189 and master loading budget control component 150 modulate rack equipment operations based upon the loading configuration of an equipment rack. In one embodiment, the modulation is performed in accordance with policies and objectives of a loading budget allocation plan or policy. The loading budget allocation plan facilitates modulation of rack equipment operational changes based upon loading configuration guidelines. For example, the loading budget allocation plan can define operational settings of the rack equipment for various equipment rack loading configurations or conditions (e.g., the type of equipment and amount of equipment loaded in an equipment rack). The loading budget implementation components analyze the loading budget allocation policy information in conjunction with equipment description information to formulate commands that direct actions on the equipment in racks 110, 120 and 130 and related support equipment. For example, the commands can direct modulation of operation settings and performance levels of the rack equipment. In one embodiment, the loading budget allocation components modulate operating conditions to maintain rack equipment operation within aggregate power consumption and heat dissipation budgets as part of the budget loading allocation guidelines. The modulations can facilitate maximization loading configurations with respect to power consumption and thermal dissipation. The loading budget allocation plans and policies can be dynamically adjusted on the fly.

With reference still to FIG. 1, there are a variety of ways in which master loading budget control component 150 and loading budget implementation components 187, 188 and 189 modulate the operation settings of equipment included in equipment rack load modulation system 100. For example, loading budget implementation components 187, 188 and 189 can modulate the frequency and operating voltage characteristics of equipment included in racks 110, 120 and 130 respectively. Loading budget implementation components 187, 188 and 189 can also instruct equipment included in racks 110 through 130 respectively to turn on or off. Alternatively, loading budget implementation components 188, 187 and 189 can instruct execution components (e.g., parallel processors, pipelines, etc.) and/or portions of a memory component (e.g., a disk array, etc.) to turn on or off.

A loading budget implementation component can make the changes in a manner that optimally balances consumption of available power and loading of an equipment rack. For example, optimally balances the thermal and power budget allocation with a performance level of the rack by providing increased power to certain types of rack equipment while reducing power supplied to other types of rack equipment. The loading budget implementation component allocates the thermal and power budget proportionally to each piece of the rack equipment contributing to the thermal budget. The loading budget implementation component modulates the rack equipment operations in accordance with the rack equipment nominal specifications.

Master loading budget control component 150 and loading budget implementation components 187, 188 and 189 can also direct operational setting changes to various other detection and support components. Auxiliary power unit 171 provides auxiliary power in accordance with directions from master loading budget control component 150 based upon loading budget allocation policy guidelines. HVAC controller 140 controls the heating, venting and cooling equipment associated with an area in which equipment racks 110, 120 and 130 are located in accordance with input from master loading budget control component 150. For example, HVAC controller 140 controls fan 141, heater 142 and an air conditioning unit (not shown) that vent, heat, and cool the area (e.g., a room) in which equipment racks 110, 120 and 130 are located.

Loading budget implementation components (e.g., 187, 188, 189 and/or 150) can also comprise an interface for facilitating user interaction with rack equipment modulation based on equipment rack loading conditions. The interface allows operators or other equipment (e.g., remote resources coupled via a network) to manually and/or automatically participate in rack equipment operational setting modulation. The interface is a mechanism for communicating information to and from an operator or user. For example, the interface can enable operator intervention and provides a variety of power supply and performance related information in a cohesive, user friendly presentation.

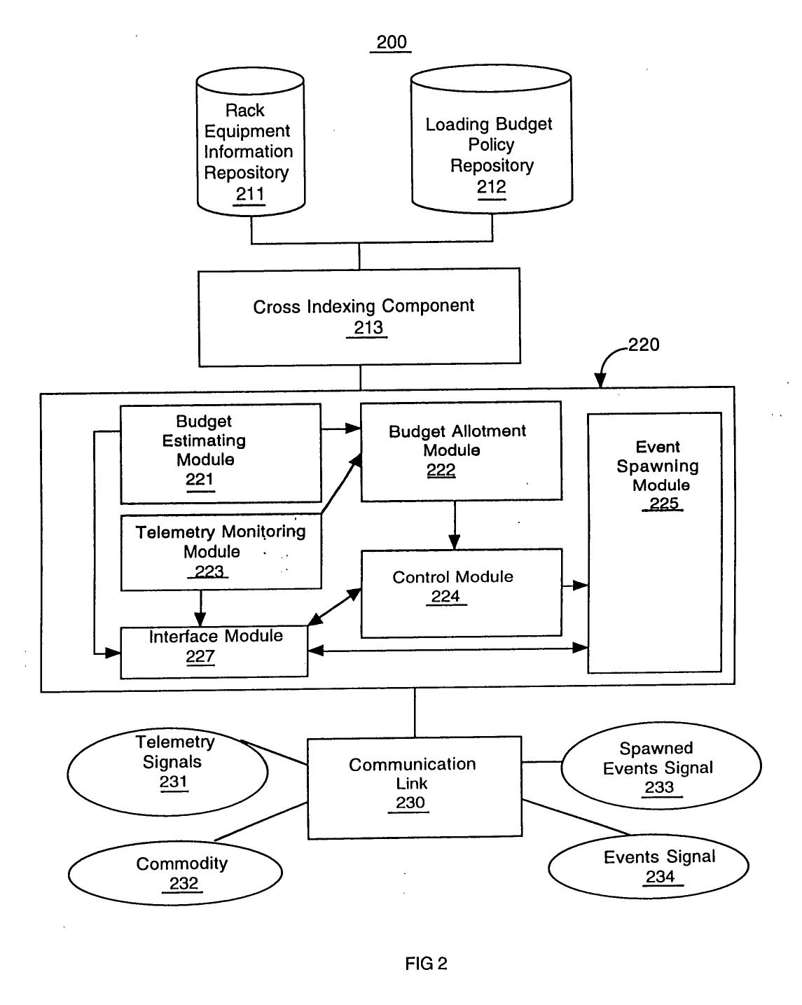

FIG. 2 is an illustration of loading budget implementation component 200, one embodiment of a present invention loading budget implementation component. Loading budget implementation component 200 includes rack equipment information repository 211, loading budget policy repository 212, cross indexing component 213, loading budget processing component 220, and communication link component 230. The components of loading budget implementation component 200 cooperatively operate to modulate operational settings of rack equipment based upon loading budget allocation policies. Equipment information repository 211 stores information about equipment included in the rack (e.g., rack equipment description information). Loading budget policy repository 212 stores information on loading budget allocation plans (e.g., policy guidelines and plan objectives). Cross indexing component 213 correlates equipment information and loading budget allocation information. Loading budget processing component 220 processes instructions for modulating operational settings associated with power purchase plan guidelines. Loading budget implementation component 200 utilizes communication link 230 for external communications. For example, loading budget implementation component 200 utilizes communication link 230 to forward and receive telemetry signals 231, commodity signals 232 (e.g., power price signal from a utility), spawned event signals 233 and trigger event signals 234.

In one embodiment, loading budget processing component 220 includes budget estimating module 221, budget allotment module 222, telemetry monitoring module 223, control module 224, event spawning module 225 and interface module 227. Budget estimating module 221 estimates a thermal and power budget for an equipment rack. Budget allotment module 222 allots the thermal and power budget to rack equipment. Telemetry collection module 223 collects characteristics and activity information of equipment associated with a loading budget allotment plan. Control module 224 generates rack equipment control commands for controlling the rack equipment in accordance with the thermal and power budget allotment. Event spawning module 225 generates thermal and power budgeting events. Interface module 227 performs interface operations.

Budget estimating module 221 can estimate budgets for a variety of equipment rack configurations and conditions. Budget estimating module 221 receives information describing an equipment rack and corresponding support functions. For example, budget estimating module 221 receives information indicating the total power available to an equipment rack and the internal cooling capabilities of the equipment rack. Based upon this information, budget estimating module 221 can estimate an aggregate power and thermal budget for an equipment rack. Budget estimating module 221 can also receive information on external cooling support (e.g., from fan 141) provided for an equipment rack and factor that information in estimates of an aggregate power and thermal budget for an equipment rack.

Budget allotment module 222 can analyze a variety of different loading budget allotment policy objectives in response to an equipment rack loading configuration. The budget allotment module 222 can determine appropriate actions for implementing the loading budget allotment plan objectives. For example, the loading budget allotment policies can be structured in accordance the amount of equipment loaded in an equipment rack. In one exemplary implementation, there are N servers loaded in an equipment rack and X represents the total aggregate power and thermal budget for the equipment rack. Each server is allocated X/N of the total aggregate power and thermal budget. The allocation can include a weighting factor based upon the type of components in the equipment rack. For example, if there are two servers and one disk array in the equipment rack, the X/N value can be weighted heavier for the servers and lighter for the disk arrays or vise versa. The budget allotment module 222 can also modulate the power and thermal budget allotment on the fly based upon equipment being added or removed from an equipment rack. The allotment can also be coordinated with other types of policy constraints. For example, an application performance policy can dictate that a particular piece of equipment be turned off and the power and thermal budget allotment can be increased for the remaining equipment in the equipment rack. The budget allotment module 222 provides an indication of the allotment to control module 224.

Telemetry monitoring module 223 can be utilized to direct the monitoring of telemetry information associated with various different equipment rack configurations. Telemetry monitoring module 223 is also readily adaptable for utilization with a variety of different types of rack equipment. Telemetry monitoring module 223 can also direct monitoring or retrieval of information for confirming operational settings and budget allotment commands are complied with. Telemetry monitoring module 223 can also direct retrieval of rack equipment description information (e.g., rack equipment operation settings and performance levels) and support equipment (e.g., HVAC units).

Control module 224 is capable of creating a variety of different commands in response to notifications received from budget allotment module 222. Control module 224 can extract command protocol and syntax requirements from rack equipment description information (e.g., included in a rack equipment repository). The commands can direct a change in rack equipment and/or support equipment operating settings. For example, the commands can direct a change in a temperature setting of HVAC support equipment and/or heat dissipation level for the rack equipment. The commands can include a command to change the operating frequency, change the voltage level of supply power or turn on/off rack equipment and/or support equipment (e.g., fan 141, heater 142, auxiliary power unit 171, etc.). The operation adjustment commands can be forwarded to rack equipment and associated support equipment. For example, control module 224 can forward operation adjustment commands to change the operation settings of the rack equipment.

Event spawning module 225 spawns loading budget allotment trigger events. Event spawning module 225 can spawn a loading budget allotment plan triggering event that causes a loading budget implementation component to interface with other loading budget implementation components. For example, loading budget implementation components 187, 188 and 189 can spawn a triggering event requesting more power that causes master loading budget implementation component 150 to direct auxiliary power 171 to increase or decrease the power supply in accordance with a predetermined power purchase plan policy.

In one embodiment of the present invention, a loading budget implementation component (e.g., 115) is included in an intelligent power distribution unit (IPDU). The IPDU can be utilized to aggregate multiple power line cords from rack equipment into a smaller number of power line cords at a rack level. In one exemplary implementation in which power cords are used as a present invention communication link, the presence of each piece of rack equipment can be detected as the rack equipment is communicatively coupled to the IDPU. In addition, information associated with the piece of rack equipment (e.g., power and thermal performance operating points, information indicating the type of rack equipment, characteristics of the rack equipment, etc.) can be automatically communicated to the IPDU. Even if a piece of rack equipment does not have an available relevant descriptive information store itself, the IPDU can sense current draw and account for unregulated use in equipment rack management policy decisions.

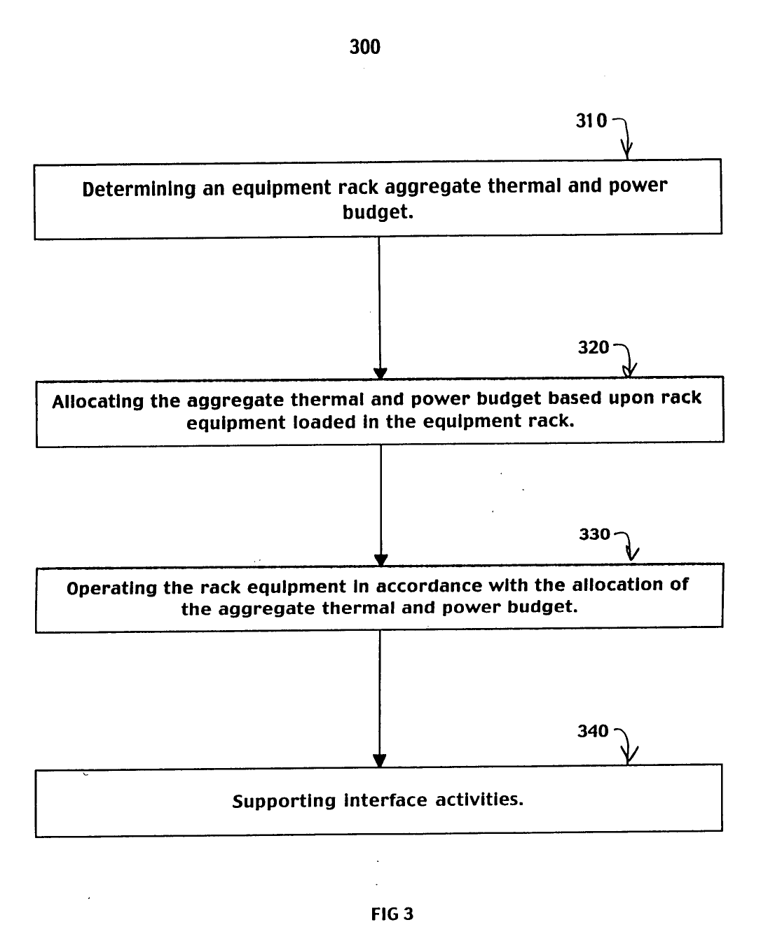

FIG. 3 is a flow chart of an equipment rack load modulation method 300 in accordance with one embodiment of the present invention. Equipment rack load modulation method 300 establishes a communication and control protocol for automatic allocation of aggregate thermal and power budget based upon the equipment loaded in a rack. The communication and control protocol also facilitates issuance of rack equipment operation commands in accordance with the allocation. Equipment rack load modulation method 300 also provides an interface for presenting information in a convenient manner to a user.

In step 310, an equipment rack aggregate thermal and power budget is determined. The aggregate thermal and power budget includes the total thermal dissipation characteristics of an equipment rack and total power available within the equipment rack. For example, information on power supplied to the equipment rack and heat dissipation features of the equipment rack is obtained and utilized to determine the equipment rack aggregate thermal and power budget. The heat dissipation feature information can include heat dissipation provided by passive cooling characteristics of the equipment rack. For example, heat dissipation provided by active cooling features of the equipment rack can include heat dissipation assistance provided by fans within the equipment rack. Active heat dissipation assistance can also be provided by external cooling support (e.g., HVAC equipment).

In step 320, the aggregate thermal power budget is allocated to rack equipment included in the equipment rack. In one embodiment, an equipment rack loading inquiry is made. For example, a telemetry monitoring module sends a query signal to equipment loaded in a rack to update or examine rack equipment information on the amount and type of equipment loaded in an equipment rack.

In step 330 rack equipment is operated in accordance with the allocation of the aggregate thermal and power budget. For example, commands are issued instructing the rack equipment to operate in accordance with the loading budget allocation. In one embodiment, the modulation is executed by adjusting a frequency and a voltage of the rack equipment. For example, the modulation is executed by turning off rack equipment associated with data processing. The command corresponds to an operation setting action set forth in a loading budget allocation plan for a particular equipment rack loading configuration. For example, the command can include determining an appropriate adjustment setting for rack equipment (e.g., heat dissipation settings) and/or support equipment (e.g., auxiliary power supply setting0. The command can also be tailored to possible actions available for a particular piece of rack equipment. For example, possible operation setting and/or performance level changes.

In one embodiment of the present invention, implementation of the power consumption modulation is checked. For example, equipment performance modulations are checked for compliance with the loading budget allotment plan guidelines. The equipment can include rack equipment and support equipment. The equipment performance modulation is directed to bring operation of the rack equipment within guidelines set for the rack in a loading budget allotment plan. In one exemplary implementation, performance modulation instructions are forwarded to the rack equipment and the response of the equipment is checked. The modulation of the equipment performance levels can change the power consumption and thermal load of the rack equipment. For example, the modulation of the equipment performance levels can result in an increase or decrease in the heat dissipated by the rack. In another example, the manipulation can include turning on and off the equipment. The directions can also include issuing a command to manipulate operation of support equipment (e.g., HVAC equipment, auxiliary power equipment, etc.).

In step 340, interface activities are supported. The loading budget allotment plan can also be adjusted on the fly. In one embodiment the loading budget allotment plan is adjusted via an interface. The interface activities include presenting information in a convenient and user friendly manner. For example, environmental condition information, equipment rack loading information, corresponding rack equipment description information and telemetry information (e.g., operating level settings) can be displayed. Similar information associated with rack support equipment (e.g.; HVAC equipment, auxiliary power, etc.) can also be presented. The interface activities also include automatically adjusting the loading budget allotment plan interactively.

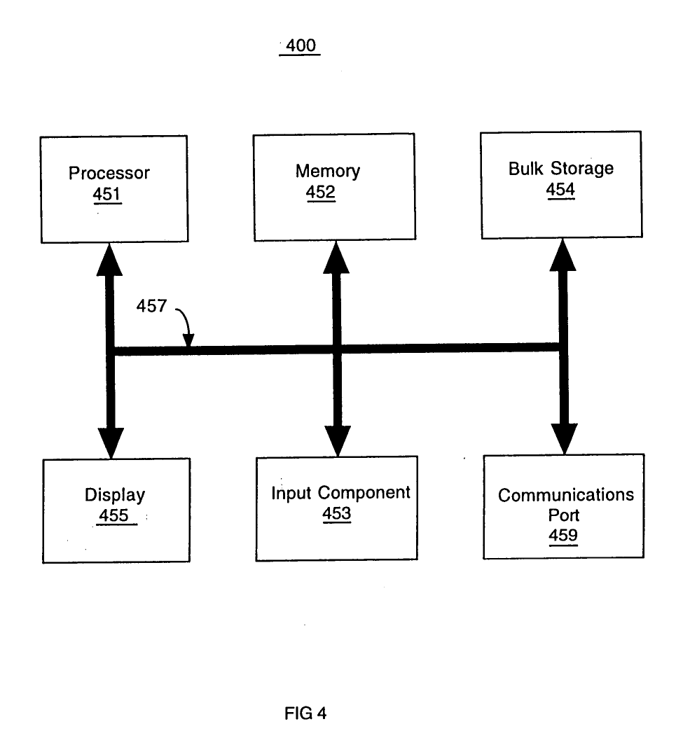

FIG. 4 is a block diagram of computer system 400, one embodiment of a computer system on which the present invention can be implemented. For example, computer system 400 can be utilized to implement loading budget processing component 220 or equipment rack load modulation method 300. Computer system 400 includes communication bus 457, processor 451, memory 452, input component 453, bulk storage component 454 (e.g., a disk drive), network communication port 459 and display module 455. Communication bus 457 is coupled to central processor 451, memory 452, input component 453, bulk storage component 454, network communication port 459 and display module 455.

The components of computer system 400 cooperatively function to provide a variety of functions, including directing rack equipment operational setting modulation in accordance with a loading budget allocation plan of the present invention. Communication bus 457 communicates information within computer system 400. Processor 451 processes information and instructions, including instructions and information for modulating rack equipment operation and performance (e.g., processor 451 processes budget estimating module 221 instructions, budget allotment module 222 instructions, telemetry monitoring module 223 instructions, control module 224 instructions, etc.). Memory 452 stores information and instructions, including instructions for implementing a loading budget allocation plan. Bulk storage component 454 also provides storage of information (e.g., rack equipment description information, policy information, etc.). One embodiment of a present interface can be implemented by input component 453, display module 455 and network communications port 459. Input component 453 facilitates communication of information (e.g., operator policy initiated changes, operator entered rack equipment description information, operator intervention in rack equipment operation changes, etc.) to computer system 400. Display module 455 displays information to a user (e.g., a graphical user interface conveying rack equipment operation settings and performance levels, rack equipment description information, a loading budget allocation plan policy information, correlation between the information, etc.). Network communication port 459 provides a communication port for communicatively coupling with a network (e.g., for communicating power purchase plan related information with a client, a utility, a remote operator and/or control center, etc.).

Thus, a present invention equipment rack load modulation system and method facilitates convenient and efficient modulation of rack equipment based upon equipment rack loading configuration. The rack equipment modulation permits automated implementation of loading budget allotment policies. Automatic direction of equipment operation setting and performance level modulation is provided to meet the rack equipment power and thermal budget load configuration objectives (e.g. power consumption and heat dissipation levels). Equipment description information, policy information and rack equipment operation modification commands are automatically communicated via communication links implementing a rack equipment management protocol. The communication links are flexibly adaptive to a variety of implementations and can be implemented on an available communication medium (e.g., power cord lines). The present invention also provides a convenient and efficient interface that can correlate diverse rack equipment management information in a unified manner.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various modifications as are suited to the particular use contemplated. It is intended that the scope of the invention be defined by the claims appended hereto and their equivalents.

1. An equipment rack load modulation method comprising:
determining an equipment rack aggregate thermal and power budget;
allocating said aggregate thermal and power budget based upon rack equipment loaded in said equipment rack; and
operating said rack equipment in accordance with said allocation of said aggregate thermal and power budget.

2. The method of claim 1 further comprising making an equipment rack loading inquiry.

3. The method of claim 2 further comprising examining the amount of rack equipment loaded in said equipment rack.

4. The method of claim 1 further comprising retrieving rack equipment description information.

5. The method of claim 4 further comprising retrieving information on heat dissipation characteristics of said rack equipment.

6. The method of claim 4 wherein said equipment rack aggregate thermal and power budget is based upon heat dissipation provided by passive cooling characteristics of said equipment rack, heat dissipation provided by active cooling features of said equipment rack, and heat dissipation assistance provided by external cooling support.

7. The method of claim 1 wherein said operating said rack equipment includes issuing commands directing said rack equipment operation in accordance with said budget allocation.

8. A computer-useable storage medium comprising computer-readable program code embodied therein for causing a computer system to implement thermal and power budget allocation instructions, comprising:
a thermal and power budget estimating module for estimating a thermal and power budget for an equipment rack;
a thermal and power budget allotment module for allotting said thermal and power budget to rack equipment in said equipment rack; and
a control module for generating rack equipment control commands for controlling said rack equipment in accordance with said thermal and power budget allotment.

9. The computer-useable medium of claim 8 wherein said control module generates commands for altering power consumption and thermal load of said rack equipment.

10. The computer-useable medium of claim 8 further comprising a thermal and power budget event spawning module for generating thermal and power budgeting events for said equipment rack.

11. The computer-useable medium of claim 8 further comprising a telemetry monitoring module for monitoring operations of said rack equipment.

12. The computer-useable medium of claim 8 wherein said thermal and power budget estimating module evaluates said equipment rack load.

13. The computer-useable medium of claim 8 wherein said control commands control a performance level of said rack equipment.

14. An equipment rack load modulation system comprising:
rack equipment for processing data;
a loading budget implementation component for modulating said rack equipment operation based upon loading of an equipment rack; and
a communications bus for communicatively coupling said rack equipment and said budget allocation component, wherein said communications bus communicates data between said thermal and power budget allocation component and said rack equipment.

15. The system of claim 14 wherein said loading budget implementation component modulates a performance frequency and a voltage of said rack equipment.

16. The system of claim 14 wherein said loading budget implementation component modulates operation of said rack equipment by switching on and off said rack equipment.

17. The system of claim 14 wherein said loading budget implementation component dynamically modulates said rack equipment operations interactively.

18. The system of claim 14 wherein said loading budget implementation component modulates said rack equipment operations in accordance with said rack equipment nominal specifications.

19. The system of claim 14 wherein said loading budget implementation component allocates said thermal and power budget proportionally to each piece of said rack equipment contributing to said thermal budget.

20. The system of claim 14 said loading budget implementation component optimally balances said thermal and power budget allocation with a performance level of said rack equipment.
